(19) United States
(12) Patent Application Publication
(10) Pub. No.: US 2005/0094747 A1
(43) Pub. Date: May 5, 2005

(54) Apparatus to estimate a channel using training sequence data for a digital receiver and a method thereof

(76) Inventor: Sung-woo Park, Suwon-si (KR)

Correspondence Address: STANZIONE & KIM, LLP, 1740 N STREET, N.W., FIRST FLOOR, WASHINGTON, DC, 20036, US

(21) Appl. No.: 10/944,700

(22) Filed: Sep. 21, 2004

(30) Foreign Application Priority Data
Oct. 29, 2003 (KR) 2003-76073

(51) Int. Cl. H04L 27/06

(52) U.S. Cl. 375/340; 375/343

(57) ABSTRACT

An apparatus to estimate a channel of a digital receiver and a method thereof. The apparatus includes a correlation estimation unit to estimate a first channel impulse response (CIR) using a correlation between input data and training sequence data, a least square (LS) estimation unit to estimate a second CIR by an LS calculation using the input data and the training sequence data, and a CIR combination unit to combine the first CIR and the second CIR to output a final CIR.

### CROSS-REFERENCE TO RELATED APPLICATIONS

This application claims the benefit of Korean Patent Application No. 2003-76073, filed Oct. 29, 2003 in the Korean Intellectual Property Office, the disclosure of which is incorporated herein by reference and in its entirety.

### BACKGROUND OF THE INVENTION

1. Field of the Invention

The present general inventive concept relates to an apparatus to estimate a channel using a training sequence signal for a digital receiver, and a method thereof. More particularly, the present general inventive concept relates to an apparatus to estimate a channel for a digital receiver and a method thereof which can precisely estimate a channel impulse response (CIR) using a training sequence signal that is a signal agreed between digital transmission and reception systems.

2. Description of the Related Art

A system for transmitting a broadcasting signal for realizing a digital broadcast is classified into a vestigial sideband (VSB) modulating system and a coded orthogonal frequency division multiplexing (COFDM) modulating system.

The VSB modulating system transmits a broadcasting signal with a single carrier. The COFDM modulating system multiplexes and transmits a broadcasting signal through a multi-channel.

In the VSB modulating system, in order to cope with a multi-path environment having a severe propagation distortion, a training sequence signal is inserted into a data frame to be transmitted. In a time domain synchronous (TDS) OFDM system that is a kind of OFDM system, an OFDM frame signal formed by inserting a training sequence signal into a data frame is transmitted.

The training sequence signal is a signal pre-agreed between a transmitter side and a receiver side, and is used to compensate for a channel distortion, which is a phenomenon that a wave is changed into a form that is not the original form due to various causes during the propagation of the wave. The training sequence signal is inserted between data frames to be transmitted, and a pseudo-noise (PN) sequence is mainly used as the training sequence signal. Hereinafter, as an agreed training sequence signal, the PN sequence will be described.

FIG. 1 is a block diagram illustrating a part of a general digital receiver. The digital receiver includes a synchronous unit 110, a channel estimation unit 120, and an equalizer 130.

The synchronous unit 110 performs a synchronizing process such as a carrier restoration and a frame sync restoration with respect to received data, and outputs sync-restored data. The channel estimation unit 120 receives the sync-restored data from the synchronous unit 110, and estimates the channel impulse response (CIR) of the received data. Generally, the CIR represents the characteristic of a multi-path channel, and has information on a position and a size of an echo.

The PN sequence among the signals received in the channel environment in which the multi-path exists, generates a plurality of echoes on a time domain according to the multi-path. On the basis of a main signal having the largest size among the plurality of echoes, a pre-echo exists before the main signal on the time domain, and a post-ghost exists after the main signal. The echoes being generated in the multi-path channel environment deteriorates the performance of the equalizer 130.

The channel estimation unit 120 is used to improve the equalizing performance of the equalizer 130 by estimating the characteristic of echoes generated in the multi-path channel environment. The CIR estimated by the channel estimation unit 120 is input to the equalizer 130, and the equalizer 130 equalizes the sync-restored data input from the synchronous unit 110 using the information representing the position and size of the echo. Accordingly, by estimating the CIR more precisely, the performance of the equalizer 130 is greatly improved.

A channel estimating method using the training data is classified into a correlation method for estimating the CIR using a correlation between the received data and the training sequence data and a least square (LS) calculating method for calculating the CIR using the received data and the training sequence data.

The correlation method has an advantage that it has a simple construction and a wide CIR estimation range since it obtains the correlation by performing a convolution of the received data and the PN sequence. However, the correlation method has a disadvantage that it basically has a big noise, and thus it is difficult to perform a precise estimation.

The LS calculating method calculates the CIR using the following equation 1, wherein “h” denotes an N×1 channel vector (that is, CIR), “A” denotes an M×N matrix composed of the training sequence data, and “y” denotes an M×1 received data vector.
h=(A^{T}A)⁻¹A^{T}y [Equation 1]

If the length of the training sequence data is “K”, “K=M+N−1” and “M>N” are obtained from the equation 1, and thus the estimable CIR range is limited to less than a half of the length of the training sequence data. Since the length of the training data is limited for the efficiency of the data transmission, the estimable range according to the LS calculating method is also limited.

Specifically, according to the LS calculating method, a precise estimation is possible irrespective of the size or number of echoes, but the estimation range is limited to less than a half of the training sequence data. Also, M×N multiplications should be performed to increase the amount of calculation, and the echoes outside the estimation range causes the noise to increase. Hence, a channel estimating method that can make up for the disadvantages of the two methods is required.

### SUMMARY OF THE INVENTION

An aspect of the general inventive concept is to solve at least the above-identified problems and/or disadvantages and to provide at least the advantages described hereinafter.

Another aspect of the present general inventive concept is to provide an apparatus to estimate a channel for a digital receiver, and a method thereof, which has a wide estimation range in a system using training sequence data, and can be used to improve the equalizing performance of an equalizer by extracting channel status information of a high reliability.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an apparatus to estimate a channel of a digital receiver including a correlation estimation unit to estimate a first channel impulse response (CIR) using a correlation between input data and training sequence data, a least square (LS) estimation unit to estimate a second CIR by an LS calculation using the input data and the training sequence data, and a CIR combination unit to combine the first CIR and the second CIR to output a final CIR.

The correlation estimation unit can output a value of “0” with respect to an echo having a size smaller than a first threshold value among echoes included in the input data. The LS estimation unit can output a value of “0” with respect to an echo having a size smaller than a second threshold value among echoes included in a specified estimation range on a time domain where an estimation operation is performed.

In an aspect of the present general inventive concept, the second threshold value is smaller than the first threshold value. It is also an aspect of the present general inventive concept that the apparatus can further include an LS range selection unit to select a specified LS estimation range on a time domain where an operation of the LS estimation unit is performed, using the first CIR output from the correlation estimation unit.

In another aspect of the present general inventive concept, the LS range selection unit can compare sizes of the echoes included in the input data using the first CIR, and can select the LS estimation range so that the echoes having relatively large sizes are included in the LS estimation range.

It is also an aspect of the present general inventive concept that the apparatus may further include a power calculation unit to calculate a power of the echoes inside the LS estimation range and a power of the echoes outside the LS estimation range using the first CIR and the LS estimation range on the time domain where the operation of the LS estimation unit is performed, and to output their power ratio.

The CIR combination unit can combine the first CIR and the second CIR using the power ratio output from the power calculation unit. Also, the CIR combination unit can output the first CIR if the power ratio is smaller than a third threshold value, and can output the second CIR with respect to the LS estimation range if the power ratio is larger than the third threshold value.

It is another aspect of the present general inventive concept that the LS calculation is performed using the following equation:
h=(A^{T}A)−A^{T}y,
where “h” denotes the second CIR that is an N×1 vector, “A” denotes the training sequence data that is an M×N matrix, and “y” denotes the input data that is an M×1 vector.

The foregoing and/or other aspects and advantages of the present general inventive concept are also achieved by providing a method of estimating a channel of a digital receiver, the method including estimating a first channel impulse response (CIR) using a correlation between input data and training sequence data, estimating a second CIR by a least square (LS) calculation using the input data and the training sequence data, and combining the first CIR and the second CIR and outputting a final CIR.

The method may further include selecting a specified LS estimation range on a time domain where the first CIR estimating operation is performed, using the first CIR. The method may further include calculating a power of the echoes inside the LS estimation range and a power of the echoes outside the LS estimation range using the first CIR and the LS estimation range, and calculating their power ratio.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a part of a general digital receiver;

FIG. 2 is a block diagram of a channel estimating apparatus, according to an embodiment of the present general inventive concept;

FIGS. 3A and 3B are views illustrating the channel estimation ranges of the channel estimating apparatus according to FIG. 2; and

FIG. 4 is a flowchart illustrating a channel estimating method performed by the channel estimating apparatus of FIG. 2, according to another embodiment of the present general inventive concept.

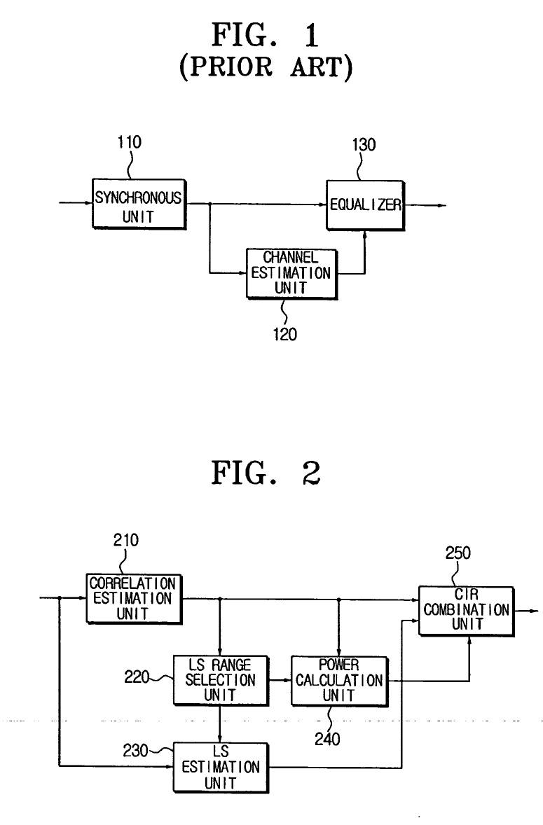

### DETAILED DESCRIPTION OF THE PREFERRED. EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

An apparatus to estimate a channel of a digital receiver and a method thereof will be described in detail.

FIG. 2 illustrates a block diagram of a channel estimating apparatus according to an embodiment of the present general inventive concept. Referring to FIG. 2, the channel estimating apparatus may include a correlation estimation unit 210, an LS range selection unit 220, an LS estimation unit 230, a power calculation unit 240, and a CIR combination unit 250.

The correlation estimation unit 210 can estimate a first channel impulse response (CIR) using a correlation between input data and training sequence data. The correlation estimation unit 210 can be a type of filter having the training sequence data as coefficient values. The correlation estimation unit 210 has a wide estimable range, but has a big noise. Accordingly, in this embodiment of the present general inventive concept, the correlation estimation unit 210 estimates the first CIR within a considerably wide correlation estimation range, and makes values below the specified threshold value “0” in order to remove the correlation noise basically generated.

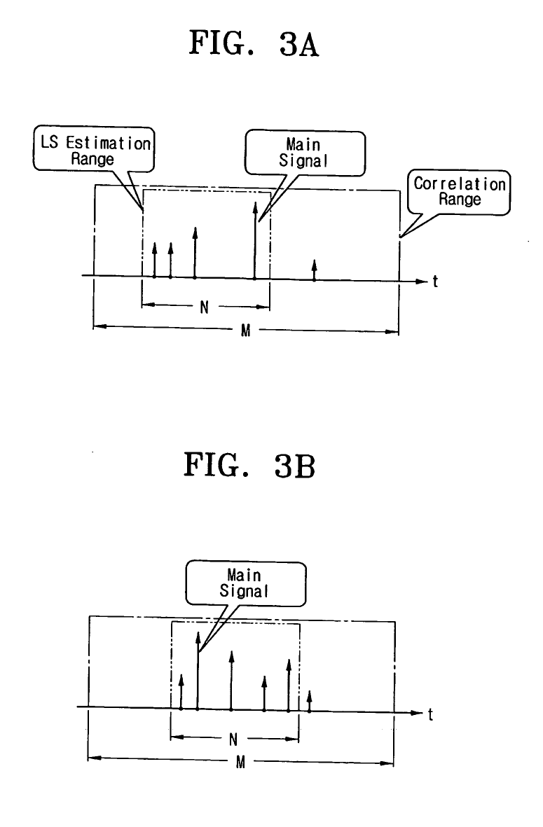

FIGS. 3A and 3B are views illustrating the channel estimation ranges of the channel estimating apparatus according to FIG. 2. Referring to FIG. 3A, the correlation estimation unit 210 estimates the CIR using the input data and the training sequence data within a section indicated as a length “M” that corresponds to the correlation estimation range on the time domain.

The LS estimation unit 230 can estimate a second CIR by calculating the LS using the input data and the training sequence data, that is, by performing a calculation of equation 1 below, also as described above. The specified LS estimation range on the time domain where the LS estimation unit 230 performs the estimation is narrower than the correlation estimation range of the correlation estimation unit 210, but the second CIR estimated is more precise than the first CIR that is an output of the correlation estimation unit 210. The LS estimation unit 230 precisely estimates the CIR within the LS estimation range, and corresponds to a type of filter having the coefficient value of “(A^{T}A)⁻¹A^{T}” in the equation 1 described below:
h=(A^{T}A)⁻¹A^{T}y, [Equation 1]
wherein “h” denotes an N×1 channel vector (that is, CIR), “A” denotes an M×N matrix composed of the training sequence data, and “y” denotes an M×1 received data vector.

The LS estimation unit 230 outputs a value of “0” with respect to the echo having a size smaller than the specified threshold value among the echoes included in the estimation range. It is an aspect of the general inventive concept that the threshold value for the output value of the LS estimation unit 230 is smaller than the threshold value used in the correlation estimation unit 210, since the LS estimation unit 230 can estimate the CIR more precisely.

The LS range selection unit 220 selects the LS estimation range of the LS estimation unit 230 using the first CIR estimated by the correlation estimation unit 210. That is, the LS range selection unit 220 selects the LS estimation range so that the echoes having relatively large sizes are included in the LS estimation range by comparing sizes of the echoes obtained from the first CIR estimated by the correlation estimation unit 210.

Referring to FIG. 3A, the LS estimation range is a section indicated as a length of “N”, and is included in the estimation range for the correlation estimation unit 210 indicated as a length of “M.” FIG. 3A shows a case in which the sizes of the pre-echoes existing on the front part of the time domain with respect to the main signal are relatively large, and the LS estimation range is selected so that the pre-echoes are included in the LS estimation range.

FIG. 3B shows a case in which the sizes of the post-echoes existing on the rear part of the time domain with respect to the main signal are relatively large, and the LS estimation range is selected so that the post-echoes are included in the LS estimation range.

The power calculation unit 240 calculates a power P1 of the echoes inside the LS estimation range of the LS estimation unit 230 and a power P2 of the echoes outside the LS estimation range using the first CIR estimated by the correlation estimation unit 210 and the LS estimation range, and outputs a power ratio P1/P2. The output signal of the power calculation unit 240 is used as a control signal to combine the first CIR that is the output of the correlation estimation unit 210 and the second CIR that is the output of the LS estimation unit 230 through the CIR combination unit 250.

The CIR combination unit 250 combines the first CIR from the correlation estimation unit 210 and the second CIR from the LS estimation unit 23, and outputs a final estimated CIR. For this, the CIR combination unit 250 uses the power ratio output from the power calculation unit 240. For example, the CIR combination unit 250 outputs the first CIR for outer parts of the LS estimation range. Inside the LS estimation range, the CIR combination unit 250 outputs the second CIR if the power ratio output from the power calculation unit 240 is larger than the specified threshold value, while the CIR combination unit 250 outputs the first CIR if the power ratio is smaller than the threshold value.

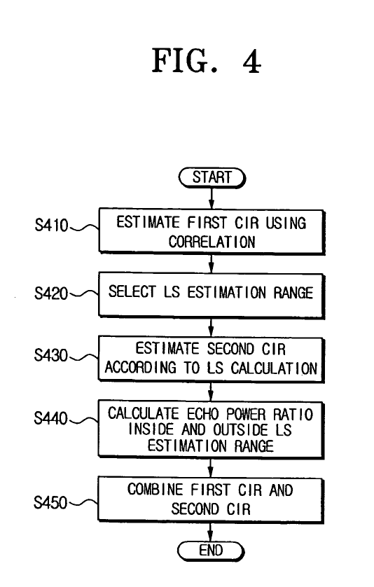

FIG. 4 is a flowchart illustrating a channel estimating method performed by the channel estimating apparatus according to an embodiment of the present general inventive concept. Referring to FIG. 4, a first CIR can be estimated using a correlation between input data and training sequence data at operation S410. The CIR estimating method using the correlation, that is, the correlation estimating method, has a wide estimable range, but has a large noise. Accordingly, in the CIR estimating operation using the correlation, that is, in the correlation estimating operation, the first CIR is estimated using the correlation within a quite wide correlation estimation range, and is output such that the echo values below the specified threshold value are made “0” in order to remove the correlation noise basically generated in the estimated first CIR.

Next, the LS estimation range is selected using the first CIR estimated at the correlation estimating operation, at operation S420. The LS estimation range is selected so that the echoes having relatively large sizes are included in the LS estimation range by comparing the sizes of the echoes obtained from the first CIR estimated at the correlation estimating operation.

For example, if the sizes of the pre-echoes existing on the front part of the time domain with respect to the main signal are relatively large, the LS estimation range is selected as the front part of the time domain including the main signal so that the pre-echoes are included in the LS estimation range as shown in FIG. 3A. If the sizes of the post-echoes existing on the rear part of the time domain with respect to the main signal are relatively large, the LS estimation range is selected as the rear part of the time domain including the main signal so that the post-echoes are included in the LS estimation range as shown in FIG. 3B.

Next, the LS calculation using the input data and the training sequence data is performed at operation S430. That is, a second CIR is estimated by performing a calculation of the equation 1 as described above at operation S430. The specified LS estimation range on the time domain at the LS estimating operation is narrower than the correlation estimation range at the correlation estimating operation, but the second CIR estimated is more precise than the first CIR.

At the LS estimating operation, a value of “0” is output with respect to the echo having a size smaller than the specified threshold value among the echoes included in the estimated CIR. It is an aspect of the present general inventive concept that the threshold value for the second CIR estimated at the LS estimating operation is smaller than the threshold value for the first CIR estimated at the correlation estimating operation.

The power P1 of the echoes in the LS estimation range and the power P2 of the echoes outside the LS estimation range are calculated using the first CIR estimated at the correlation estimating operation and the LS estimation range selected at the LS estimation range selecting operation, and then their power ratio P1/P2 is calculated at operation S440.

Next, the final estimated CIR is output through a combining of the first CIR estimated at the correlation estimating operation and the second CIR estimated at the LS estimating operation at operation S450. In order to combine the first CIR estimated at the correlation estimating operation and the second CIR estimated at the LS estimating operation, the power ratio calculated at the power ratio calculating operation is used. For example, the first CIR is output for the outer parts of the LS estimation range, and in the LS estimation range, the second CIR is output if the calculated power ratio is larger than the specified threshold value, while the first CIR is output if the power ratio is smaller than the threshold value. The finally output CIR is used to perform a more accurate equalization.

As described above, according to the channel estimating apparatus for a digital receiver according to FIG. 2, the whole channel estimation error can be greatly reduced with a wide estimation range ensured by more precisely estimating the CIR with respect to a part where large echoes closely occur.

Also, the equalization performance can be improved by performing the equalization in the digital receiver using the more precisely estimated CIR.

The present general inventive concept can be realized as a method, an apparatus, and a system. When the present general inventive concept is manifested in computer software, components of the present general inventive concept may be replaced with code segments that are necessary to perform the required action. Programs or code segments may be stored in media readable by a processor, and transmitted as computer data that is combined with carrier waves via a transmission media or a communication network.

The media readable by a processor include anything that can store and transmit information, such as, electronic circuits, semiconductor memory devices, ROM, flash memory, EEPROM, floppy discs, optical discs, hard discs, optical fiber, radio frequency (RF) networks, etc. The computer data also includes any data that can be transmitted via an electric network channel, optical fiber, air, electro-magnetic field, RF network, etc.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An apparatus to estimate a channel of a digital receiver, comprising:
a correlation estimation unit to estimate a first channel impulse response (CIR) using a correlation between input data and training sequence data;
a least square (LS) estimation unit to estimate a second CIR by an LS calculation using the input data and the training sequence data; and
a CIR combination unit to combine the first CIR and the second CIR to output a final CIR.

2. The apparatus of claim 1, wherein the correlation estimation unit outputs a value of “0” with respect to an echo having a size smaller than a first threshold value among echoes included in the input data.

3. The apparatus of claim 2, wherein the LS estimation unit outputs a value of “0” with respect to an echo having a size smaller than a second threshold value among echoes included in a specified estimation range on a time domain where an estimation operation is performed.

4. The apparatus of claim 3, wherein the second threshold value is smaller than the first threshold value.

5. The apparatus of claim 1, further comprising an LS range selection unit to select a specified LS estimation range on a time domain where an operation of the LS estimation unit is performed, using the first CIR output from the correlation estimation unit.

6. The apparatus of claim 5, wherein the LS range selection unit compares sizes of the echoes included in the input data using the first CIR, and selects the LS estimation range so that the echoes having relatively large sizes are included in the LS estimation range.

7. The apparatus as claimed in claim 1, further comprising a power calculation unit to calculate a first power of the echoes inside the LS estimation range and a second power of the echoes outside the LS estimation range using the first CIR and the LS estimation range on the time domain where the operation of the LS estimation unit is performed, and outputs a power ratio using the first and second powers.

8. The apparatus of claim 7, wherein the CIR combination unit combines the first CIR and the second CIR using the power ratio output from the power calculation unit.

9. The apparatus of claim 8, wherein the CIR combination unit outputs the first CIR if the power ratio is smaller than a threshold value, and outputs the second CIR with respect to the LS estimation range if the power ratio is larger than the threshold value.

10. The apparatus as claimed in claim 1, wherein the LS calculation is performed using the following equation:
h=(A^{T}A)⁻¹A^{T}y
wherein “h” denotes the second CIR that is an N×1 vector, “A” denotes the training sequence data that is an M×N matrix, and “y” denotes the input data that is an M×1 vector.

11. A method of estimating a channel of a digital receiver, comprising:
estimating a first channel impulse response (CIR) using a correlation between input data and training sequence data;
estimating a second CIR by a least square (LS) calculation using the input data and the training sequence data; and
combining the first CIR and the second CIR and outputting a final CIR.

12. The method of claim 11, wherein the correlation estimating operation outputs a value of “0” with respect to an echo having a size smaller than a first threshold value among echoes included in the input data.

13. The method of claim 12, wherein the LS estimating operation outputs a value of “0” with respect to an echo having a size smaller than a second threshold value among echoes included in a specified estimation range on a time domain where an estimation operation is performed.

14. The method of claim 13, wherein the second threshold value is smaller than the first threshold value.

15. The method of claim 11, further comprising selecting a specified LS estimation range on a time domain where the first CIR estimating operation is performed, using the first CIR.

16. The method of claim 15, wherein the LS range selecting operation compares sizes of the echoes included in the input data using the first CIR, and selects the LS estimation range so that the echoes having relatively large sizes are included in the LS estimation range.

17. The method of claim 15, further comprising calculating a first power of the echoes inside the LS estimation range and a second power of the echoes outside the LS estimation range using the first CIR and the LS estimation range, and calculating a power ratio using the first and second powers.

18. The method of claim 17, wherein the final CIR outputting operation combines the first CIR and the second CIR using the calculated power ratio.

19. The method of claim 18, wherein the final CIR outputting operation outputs the first CIR if the power ratio is smaller than a threshold value, and outputs the second CIR with respect to the LS estimation range if the power ratio is larger than the threshold value.

20. The method of claim 11, wherein the LS calculation is performed using the following equation:
h=(A^{T}A)⁻¹A^{T}y
wherein “h” denotes the second CIR that is an N×1 vector, “A” denotes the training sequence data that is an M×N matrix, and “y” denotes the input data that is an M×1 vector.
